(19) United States
(12) Patent Application Publication
(10) Pub. No.: US 2008/0044023 A1
(43) Pub. Date: Feb. 21, 2008

(54) Secure Data Transmission

(76) Inventors: Meir Zorea, Rehovot (IL); Ram Cohen, Tel Aviv (IL)

Correspondence Address: FAY SHARPE LLP, 1100 SUPERIOR AVENUE, SEVENTH FLOOR, CLEVELAND, OH, 44114, US

(21) Appl. No.: 11/578,639

(22) PCT Filed: Apr. 19, 2005
(86) PCT No.: PCT/IL05/00411

§ 371 Date: Oct. 22, 2007

Related U.S. Application Data
(60) Provisional application No. 60/521,398, filed on Apr. 19, 2004.

(51) Int. Cl. H04L 9/12; H04L 9/14

(52) U.S. Cl. 380/270; 713/153

(57) ABSTRACT

A system for transmitting secure data between a sender's terminal equipment and a recipient's terminal equipment over a network, and a corresponding method of use: the system comprising a sender's encryption server and a recipient's encryption server; each of the encryption servers comprise a data receiver, a decryptor, an encryptor and a transmitter; the sender's encryption server being data connectable to the sender's terminal equipment over a first link of the network and to the recipient's encryption server over a second link of the network; the receiver's terminal equipment being further data connectable to the recipient's terminal equipment over a third link of the network.

### FIELD OF THE INVENTION

The present invention is directed to providing a method and system for securing data transmission between end user telecommunication equipment over a network, particularly but not exclusively for securing electronic mail over the Internet.

### BACKGROUND OF THE INVENTION

The information age relies heavily on the transfer of data between computers, mobile phones and other telecommunication equipment. Effective and convenient data transfer relies on standardized data formats, such that different users using very different equipment can communicate with each other. To enable accurate data transmission over large distances, data is digitized, text is encoded in ASCII, documents are formatted in rich text format, and other similar standardized systems are used to ensure maximum reproducibility of transmitted data between different users using widely different terminal equipment.

Much data, such as many websites, academic databases and libraries are readily accessible to anyone, and are considered as being in the public domain, albeit some access, particularly commercial use, may require payment, such as copyright royalties, for example. Other data are considered private or confidential, and although controlled, easy, cross-platform transmission to specific parties is desirable; it is desirable to protect such data from prying eyes. This may be because of the data having a personal nature, to protect patient privacy, client-attorney privilege, for commercial reasons or because of issues of national security, for example.

One way to protecting data files, such as e-mails (electronic messages) during transmission, is to use some type of encryption. Encryption is the process of changing text so that it is no longer easy to read. Non-encrypted e-mails have been compared to open books' or post cards, since they may be read by anyone. With encryption however, only the intended recipient will be able to open and read the message, and many types of encryption are known.

Almost all modern encryption methods rely on a ‘key’, which is a particular number or string of characters used to encrypt, decrypt, or both. One widely used encryption technique is what is commonly known as ‘symmetrical’ encryption, or ‘Private key’ encryption. Both parties share an encryption key, and the encryption key and the decryption key are identical. The key is used by the sender to lock data prior to its transmission, and the recipient requires knowledge of the key to open the message on its receipt. One difficulty is sharing the key, i.e. safely transmitting it to recipient. Generally, for convenience and to help both sender and recipient remember the encryption key, a meaningful number or letter string is used, such as the name of a relative, a famous person or pet, the title of a song or a phone number. This tendency does however somewhat limit the effectiveness of such symmetrical keys, since easily remembered or meaningful keys are more easily broken.

When each communicating pair uses a different key, it is necessary to store the keys in a list or database, which is, itself, a security risk. To overcome the problem of remembering or securing a long list of keys, a group of users, such as all members of a corporation may use the same encryption key. The consequence of grouping users in this manner is that to enable encrypted communication between all group-members, each member is only requires to remember one key. However, grouping users in this manner entails a security risk in that once security is breached all data transfer between all group members is insecure. One threat to data security is gifted computer hackers, but another threat is simply that an individual may simply cease to be a member of the group. If the contract of an employee of a corporation is terminated, for example, to provide adequate protection of data transmission between members of the corporation it may be necessary to change all passwords and encryption keys. This will be critical if such a former employee goes to work for a competitor, for example. Disseminating new encryption keys in a secure manner is itself, not trivial.

Also known, is asymmetrical encryption, otherwise known as ‘public key encryption’. It operates using a combination of two keys: a ‘private key’ and a ‘public key’, which together form a pair of keys.

The sender asks the intended recipient for the public (encryption) key, encrypts the message, and sends the encrypted message to the intended recipient. Only the intended recipient can then decrypt the message—even the original sender cannot read the message to be sent once it is encrypted. The private key is kept secret on the recipient's computer since it is used for decryption, whereas the public key, which is used for encryption, is given to anybody who wants to send encrypted mail to the intended recipient. Thus in public key encryption, only the intended recipient's private key can unlock the message encrypted with the corresponding public key thereof. When a sender wishes to share a secret with an intended recipient using public key encryption, he first asks the intended recipient for his public key. Next, sender uses the intended recipient's public key to encrypt the message. The sender sends message to the intended recipient. The intended recipient uses his private key to decrypt sender's message. Public key encryption works if the intended recipient guards his private key very closely and freely distributes the public key.

The sender's encryption program uses the intended recipient's public key in combination with the sender's private key to encipher the message. When recipient receives Public-Key encrypted mail, he uses his Private Key to decipher it. Decryption of a message enciphered with a public key can only be done with the matching private key. The two keys form a pair, and it is most important to keep the private key safe and to make sure it never gets into the wrong hands, that is, any hands other than those of recipient.

Another crucial point concerning public key encryption is the distribution of the public key. Public key encryption is only safe and secure if the sender of an enciphered message can be sure that the public key used for encryption belongs to the intended recipient. A third party impersonating the intended recipient can produce a public key with the recipient's name and give it to the sender, who uses the key to send important information in encrypted form. The enciphered message is intercepted by the third party, and since it was produced using their public key they have no problem deciphering it with their private key, and in this manner credit card data may be obtained fraudulently, for example. Consequently, it is mandatory that a public key is either personally given to the sender by the recipient, or is authorized by a certificate authority.

Certification of public keys in this manner requires support resources and is costly. Since the private key of a certified asymmetrical encryption key is typically a long string of random digits or letters, it cannot be remembered by user, and it is impractical to type out each time. Consequently, such private keys are stored on their owner's computer. Computer failure, due to viruses or mechanical failure for example, often results in the private key being irretrievably lost. Since the private key is stored on hard disk of recipient, it is far from immune to hackers. Loss of the private key makes encrypted messages unreadable and is both costly and inconvenient to replace.

Nevertheless, most secure email programs use public key encryption. Intended e-mail receivers post their encryption key somewhere accessible, where potential senders can locate it. The sender uses that key to encrypt the message, thus ensuring that only the intended receiver can decrypt it. This works fairly well, but has the disadvantage that one can only send encrypted mail to receivers using a secure email program, and having a posted public key.

Of course, the actual data transmitted need not be encrypted. In SSL (Secure Socket Layer), the data transporter is encrypted. Indeed any of the OSI seven layers may be encrypted.

In general therefore, symmetrical encryption is faster and simpler than and asymmetrical methods. Since certification is not required, symmetrical encryption is also cheaper. Symmetrical encryption is however, typically less reliable and convenient.

Cryptanalysis, or the process of attempting to read the encrypted message without the key, is very much easier with modern computers than it has ever been before. Modern computers are fast enough to allow for ‘brute force’ methods of cryptanalysis—or using every possible key in turn until the ‘plain text’ version of the message is found.

The longer the key, the longer it takes to use the ‘brute force’ method of cryptanalysis—but it also makes the process of encrypting and decrypting the message slower. Key length is very important to the security of the encryption method—but the ‘safe’ key length changes every time CPU manufacturers bring out a new processor.

Because the computational power required for cracking a key increases exponentially with the length of the key, longer keys provide more security. For symmetric keys, 128 bit keys are commonly accepted as secure, for asymmetric, 1024 to 2048 bit. 40 bit symmetric keys take only a couple of hours to crack open by brute force using widely available computing power, and 40 bit asymmetric keys would fall much quicker. With asymmetrical approaches, such as GPG and SSL, because 512/1024/2048 bit keys take heavy toll on systems few people actually encrypt full data using RSA. In SSL and other technologies, only random symmetrical key is encrypted with asymmetrical encryption, and the actual data is encrypted using a symmetrical cipher. Indeed, this is exactly what the public/private key approach was designed for—secure exchange of keys used to encrypt main data.

Yet another popular encryption method called a “hash function,” has been commonly used by Web site operators to scramble online transmissions containing sensitive information such as credit-card information, Social Security numbers and the like. The method, involving an algorithm, generates digital fingerprints, or “hashes,” by performing an equation on a piece of information, switching the order of some bits, cutting down the result to a fixed length and resulting in a fingerprint. Until quite recently, Hash functions were thought to be impenetrable, but it has now been determined that they are not as resistant to hackers as previously thought.

In summary, encryption does not make data absolutely secure. Not using encryption however, means that any data in transit is as easy to read as the contents of a postcard sent in regular mail. Encryption at least ensures that anyone who does read private messages has worked hard at it.

U.S. Pat. No. 5,751,813 to Dorenbos particularly addresses the issue of sending the same message to multiple recipients using individual encryption keys. If the sender has to encrypt the message each time using the public key of a different recipient for the message, the process is troublesome. The encryption and transmission process consumes a lot of time and processing power, and is thus impractical for portable devices, since the sender's terminal equipment may be rendered unavailable for other activities by the user during the encryption and transmission time period. Furthermore, if the user has a portable communication device, such as a laptop computer, the user's battery may run out of power before encryption and transmission of each message has occurred. Dorenbos' solution proposes use of an encryption server for encrypting messages, wherein the encryption server receives a first encrypted message from a sender and decrypts the encrypted message using a first key, yielding a decrypted message comprising (i) a second encrypted message, (ii) an identification of a sender of the first encrypted message, and (iii) an identification of a first recipient. The second encrypted message, the identification of the sender, and the identification of the first recipient are determined from the decrypted message. The second encrypted message and the identification of the sender are then encrypted with a second key, yielding a third encrypted message, and the third encrypted message is transmitted to the intended recipient. Since the public key is only stored on the encryption server and the encryption with recipient's key is performed using the encryption server, sender's resources are not tied up by this encryption process. In this manner, the encryption server encrypts the user's data message individually for each different recipient using that particular recipient's public key. Individual communication units need not store the public keys of all possible recipients, but instead need store only the encryption server's public key. Encryption of the recipient's ID(s) helps to secure the identity of the recipient(s) and eliminates a source of information for traffic analysis by undesired readers/interceptors of such information.

A disadvantage of Dorenbos' solution is that for it to work, of necessity, the so-called encryption server includes a database including a list of sender and recipient identities and the public keys of each identity. Indeed, as pointed out by Dorenbos, for better security, the encryption server should be a physically secured, e.g., locked away with limited access, because unencrypted information is present therein. For communicating between different members of air organization, such as workers of a corporation, this is often convenient. However, particularly when communicating between different corporations, this is not always desirable. Typically corporations know and trust their own server security arrangements, but not those of other corporations, possibly competitors, with whose members, nevertheless, it is necessary, to communicate.

The present invention addresses the sensitive issue of secure data transmission, ensuring confidentiality thereof, particularly between organizations, and a novel solution is proposed, for which a narrow patent is requested in this crowded art.

### SUMMARY OF THE INVENTION

In a first aspect, the present invention is directed to providing a method of securely sending data from a sender to a recipient over a network, comprising the steps of:
(a) encrypting said data at terminal equipment of the sender via a first encryption key, thereby producing first encrypted data;
(b) transmitting said first encrypted data from said terminal equipment of said sender to a sender's encryption server;
(c) decrypting said first encrypted data at sender's encryption server using a first decryption key;
(d) identifying recipient's encryption server;
(e) establishing communication between sender's encryption server and recipient's encryption server;
(f) re-encrypting the data using a second encryption key, thereby producing second encrypted data;
(g) transmitting said second encrypted data from said sender's encryption server to said recipient's encryption server;
(h) decrypting said second encrypted data at said recipient's encryption server using a second decryption key;
(i) re-encrypting said data at the recipient's encryption server with a third encryption key thereby producing third encrypted data;
j) transmitting said third encrypted data to said recipient;
(k) receiving said third encrypted data by said recipient, and
(l) decrypting the third encrypted data with a third decryption key.

The first encryption key of step (a) and the first decryption key of step (c) may be symmetrical key pairs or asymmetrical key pairs.

Similarly the second encryption key of step (f) and the second decryption key of step (h) may be symmetrical key pairs or asymmetrical key pairs.

Furthermore, the third encryption key of step (i) and the third decryption key of step (l) may be symmetrical key pairs or asymmetrical key pairs.

The servers may be connected over the internet, peer-to-peer, or any combination thereof.

Typically the sender's encryption server and the recipient's encryption server are part of a hierarchical arrangement of servers, and step (e) of establishing communication between sender's encryption server and recipient's encryption server is achieved by each encryption server in said hierarchical arrangement of servers reporting back to servers thereabove regarding identity of accounts held therewith.

Optionally, where the sender's encryption server receiving data from the sender does not recognize intended recipient thereof, said sender's encryption server queries a master encryption server thereabove re address of said recipient's encryption server, and so on up hierarchical arrangement until an address of said recipient's encryption server is determined.

The sender's encryption server may comprise a server on a node of the network, or a plurality of servers distributed over a plurality of nodes of the network.

Similarly, the recipient's encryption server may comprise a server on a node of the network, or a plurality of servers distributed over a plurality of nodes of the network.

The network may be a LAN, a WAN, an intranet or the Internet, for example.

In a second aspect the present invention is directed to providing an encryption server comprises a data receiver, a decryptor, an encryptor and a transmitter for facilitating secure data transmission by the method hereinabove.

In a third aspect the present invention is directed to providing a system for transmitting secure data between a sender's terminal equipment and a recipient's terminal equipment over a network, the system comprising: a sender's encryption server and a recipient's encryption server; each of said encryption servers comprising a data receiver, a decryptor, an encryptor and a transmitter; the sender's encryption server being data connectable to the sender's terminal equipment over a first link of the network and to the recipient's encryption server over a second link of the network; and the receiver's terminal equipment being data connectable to the recipient's terminal equipment over a third link of the network.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details; the description taken with the drawings making apparent to those skilled in the art how the several forms of the invention may be embodied in practice. In the accompanying drawings:

FIG. 1 is a flowchart illustrating a prior art method transmitting secure data over a network.

FIG. 2 is a schematic block diagram of the system required for implementing the method of FIG. 1.

FIG. 3 is a flowchart illustrating the method of transmitting secure data over a network in accordance with the present invention.

FIG. 4 is a schematic block diagram of the system required for implementing the method of FIG. 3.

FIG. 5 is a schematic block diagram of the system of the invention wherein a plurality of encryption servers are shown, arranged in a hierarchical arrangement.

### DETAILED DESCRIPTION OF THE EMBODIMENTS

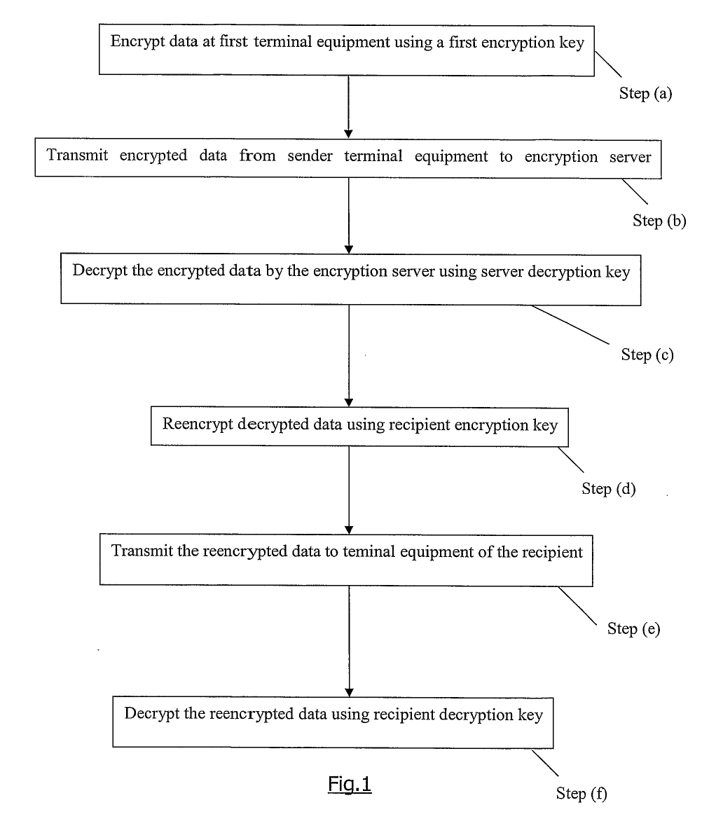

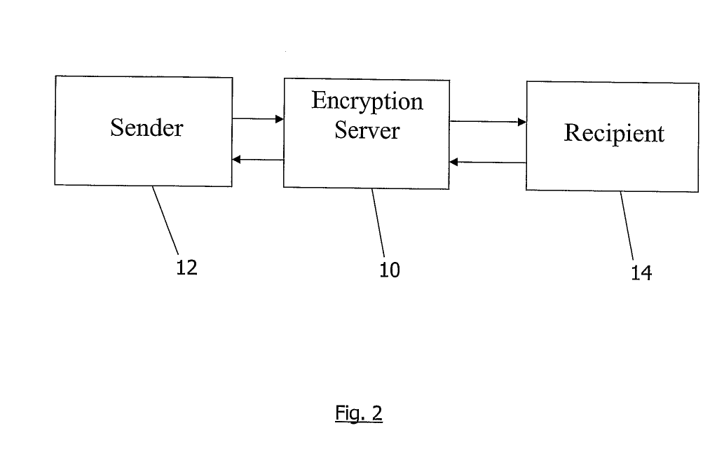

Referring simultaneously to FIG. 1 and FIG. 2, a prior art solution is shown, illustrating how an encryption server 10 can mediate between a sender's terminal equipment 12 and a receiver's terminal equipment 14 by encrypting data at the sender's terminal equipment 12 using a first encryption key (step a); then transmitting the encrypted data from the sender's terminal equipment 12 to the encryption server 10 (step b) where it the encrypted data is then decrypted by the encryption server 10 using the appropriate decryption key (step c). The encryption server 10 re-encrypts the decrypted data using a second encryption key (step d) and transmits the re-encrypted data to the terminal equipment of the intended recipient 14 (step e), where the re-encrypted data is then decrypted using the appropriate technique (step f).

In the method of FIG. 1, steps (a) and (c) can use any prior art encryption technique such as symmetrical encryption, asymmetrical encryption or hash encryption, for example. Similarly, steps (d) and (f) can use any prior art encryption—decryption such as symmetrical encryption, asymmetrical encryption and hash encryption.

The method is elaborated on in U.S. Pat. No. 5,751,813 to Dorenbos which particularly addresses the issue of sending encrypted e-mails to a group, perhaps department members of a large corporation or a management team thereof. As described therein, the encryption server is typically a server on a node in a network; however the encryption server may be distributed over a plurality of nodes of the network, perhaps for load balancing purposes.

The reader is urged to study U.S. Pat. No. 5,751,813 to Dorenbos which describes the state of the art. Essentially the invention described therein relates to a server on a node of a network that is able to receive encrypted data from a sender, run appropriate decryption procedure, re-encrypt the data again, rerun appropriate encryption procedure for subsequent decryption by intended recipient. The Dorenbos system addresses the issue of a sender using a laptop computer to transmit e-mails to a plurality of recipients using RF transmission, where the computing requirements for encryption seriously drain the computer's resources, particularly the battery thereof.

'813 to Dorenbos does not, however, pro-vide a fully secure system. Particularly it will be noted that all senders and recipients using the system have to implicitly trust the security of the encryption server, particularly if symmetrical encryption is used, as is desirable for speed, convenience etc.

Secure e-mail servers, SES, have been developed by Aliroo, and are described in literature available therefrom. Aliroo's Secure E-mail Servers act as mediators, replacing one encryption key with another, enabling a sender to encrypt with his encryption key, are known in the prior art, and have been described by Aliroo, in the past. Aliroo's prior art solution relies on asymmetrical keys, whereby a sender uses the public key of a server to encrypt his message; the server uses its private key to decrypt same, and re-encrypts the message using the public key of the intended recipient. In consequence, all recipients must have digital certificates and all these digital certificates must be accessible to all servers to enable changing keys as necessary.

As with the system described by '813 to Dorenbos, the e-mail server of Aliroo's technology is required to know the public keys of all potential subscribers, and the server must, therefore, be trusted as being secure by all users thereof. Due to their inherent expense, digital certification is not a practical solution for all members of a large organization. Furthermore by its nature, digital certification limits each user to a specific hardware terminal, and does not allow receiving encrypted e-mail on any networked terminal. In scenarios such as for when sender and recipient of e-mails do not have full confidence in the security of a single encryption server (or a distributed encryption server), both the system and method described in '813 to Dorenbos and the prior art Aliroo solution have been found lacking.

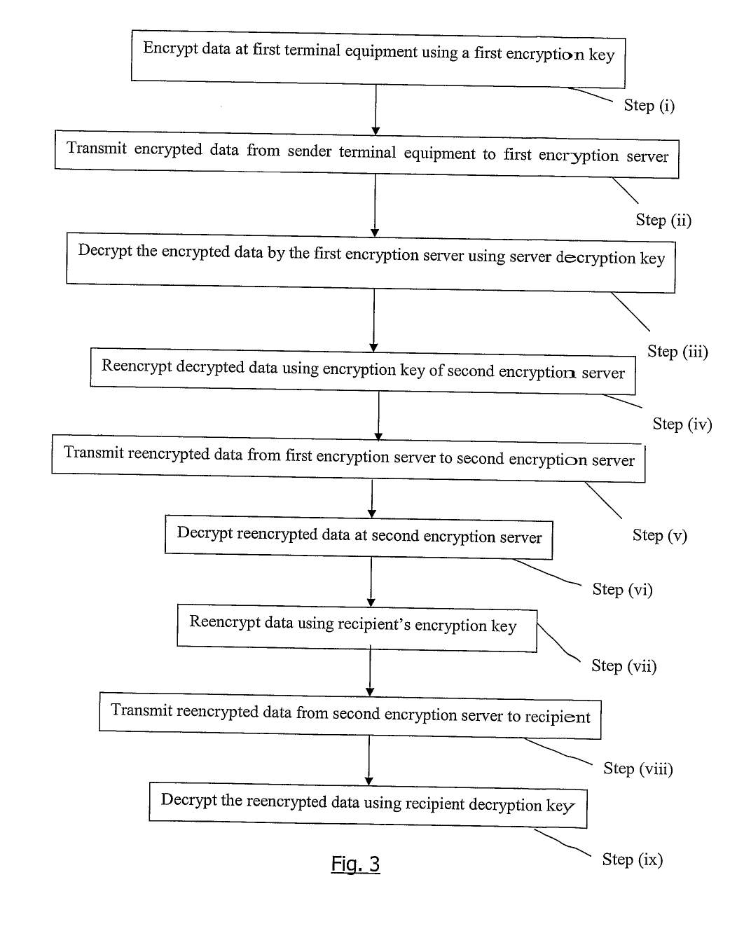

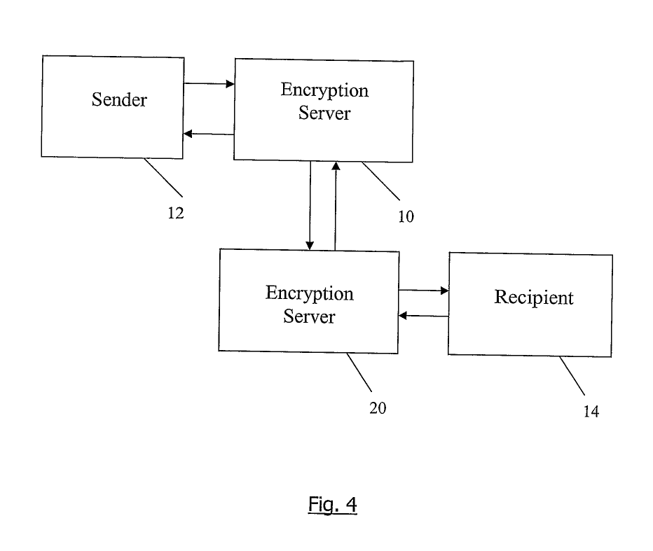

Instead of a single encryption server 10 mediating between a sender's terminal equipment 12 and a receiver's terminal equipment 14 by encrypting data at the sender's terminal equipment 12 using the method of FIG. 1, with reference to FIGS. 3 and 4, the method and system of a first embodiment of the present invention is now described wherein, data is encrypted by sender using a first encryption key (step (i)), and then the encrypted data is transmitted from the sender's terminal equipment 12 to an encryption server 20 (step (ii), and the encrypted data is then decrypted by the encryption server 20 using the appropriate decryption key (step (iii)). Now instead of re-encrypting the data using recipient's encryption key, in the present invention, the first encryption server 20 re-encrypts the decrypted data using a second encryption key of a second encryption server 30 (step (iv))—generally the public key

of the second encryption server, and transmits the re-encrypted data to the second encryption server 30 (step (v)), where it is decrypted (step (vi)) using the appropriate technique, generally the private key thereof. Only now is the decrypted data at the second encryption server 30 encrypted with the recipient's key (step (vii)) and transmitted (step (viii)) to the terminal equipment of the intended recipient 14, where the re-encrypted data is then decrypted using the recipient's key (step (ix)).

One advantage of the method of the invention as shown in FIG. 3 over the method of the prior art as shown in FIG. 1, is that sender 12 and recipient 14 can send and receive electronic mail using fast, convenient and less costly symmetrical encryption, changing their passwords as often as they like, with little difficulty or cost incurred thereby. Thus although steps (i) and (ii) can use any prior art encryption technique, symmetrical encryption will provide adequate security in many scenarios. Similarly, steps (vi) and (vii) can use any prior art encryption-decryption technique. The sender 12 chooses the encryption technique best suited to senders' 12 needs and capabilities and the recipient 14 chooses the encryption technique best suited to recipient's 14 needs and capabilities. Both recipient and sender need trust their keys to only a limited number of encryption servers, typically one.

The system and method described hereinabove and shown in FIGS. 3 and 4 is particularly useful for communicating between users working for different organizations, each using a corporate server and not trusting the security of each other's network. In such a scenario, only telecommunication between servers will typically require certified asymmetric keys.

The present invention thus provides a secure method of passing data such as e-mail messages by encryption, wherein each sender and each recipient is subscribed to a server that is considered by the party concerned as being secure (trusted).

There is no need for the sender 12 to even know the identity of the recipient trusted encryption server 30, and similarly there is no need for the recipient 14 to know the identity of the sender trusted encryption server 20. Such a state of affairs might happen where user or recipient uses an e-mail account hosted by a commercial host on a commercial server, for example. There is, nevertheless, a need for sender trusted encryption server 20 to identity with which trusted encryption server 30 the recipient is subscribed.

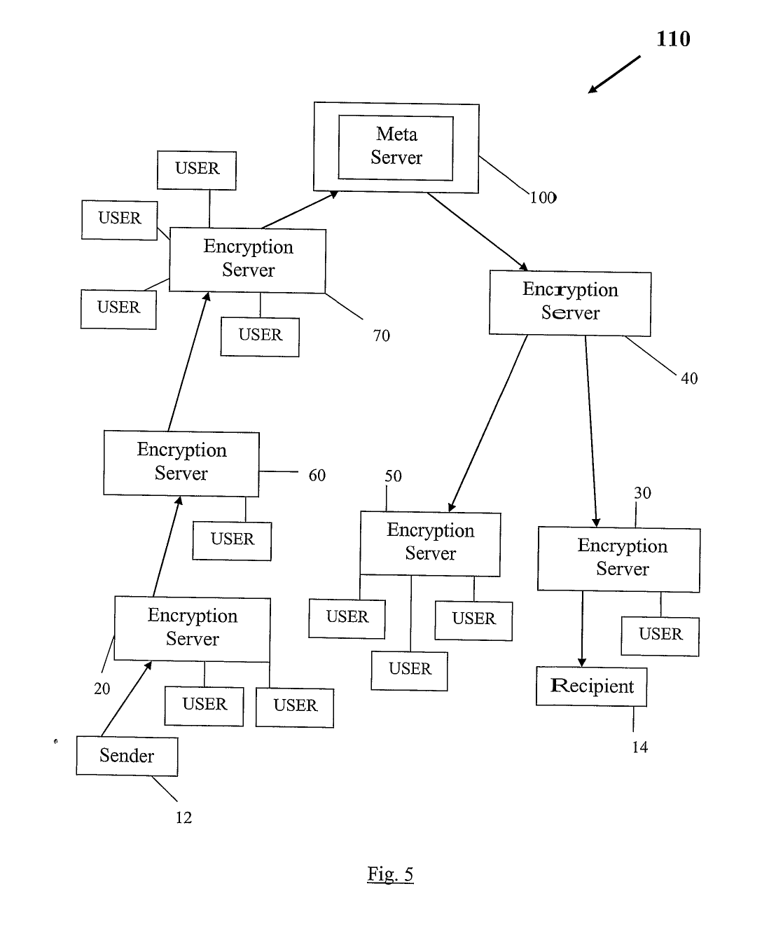

Referring to FIG. 5, one way in which this may be accomplished is for encryption servers 10n, to be arranged in a hierarchical structure 110, such that each encryption server reports to a master server, and eventually to a meta-server 100 at the apex of the hierarchical structure 110. Using such an arrangement, where the sender's 12 encryption server 20 does not recognize address of intended recipient 14, sender's 12 encryption server 20 asks its master encryption server 60 whether master encryption server 60 knows with which encryption server the recipient 14 is serviced. Such a query may be transmitted up the hierarchical chain of master servers 60, 70, until either a positive response is received, or the meta-server 100 at the top of the pyramid is reached, which will certainly know where the recipient 14 is registered.

Such a hierarchical server arrangement 110 may operate in a number of ways. For example, in one modus operandi, each server 10n periodically reports identity of users associated therewith up the line, perhaps every hour or so, and also floats the public key of the server back up the line. The sender 12 trusted encryption server 20 will request knowledge of recipient 14 from master server 60, and then from master server 70, and so on, back up the line. When a server having knowledge of recipient 14 is contacted, (in the example shown in FIG. 5, the meta server 100), the identity of recipient 14 trusted server 30 is passed on to sender 12 trusted server 20, and then the public key of recipient 14 trusted server 30 is transmitted to sender 12 trusted server 20 for encryption of the message, which may be achieved using secure SSL or S/MIME encryption, for example. Of course, the identity of the relevant trusted server 30, i.e. its nodal address may be transmitted via the master server, and only after direct contact is made and public key of recipient trusted server is requested by sender 12 trusted server 20, is the public key transmitted therebetween. Other essentially equivalent schemes based on the double trusted server, and the hierarchical server structure described hereinabove will now be apparent to the man of the art. Furthermore, it will be appreciated that the hierarchical structure described hereinabove is merely a preferred method of establishing peer-to-peer communication between sender trusted and user trusted servers. Prior art peer-to-peer communication establishing algorithms may be substituted instead. Indeed a message passed from a sender via a sender trusted server may be routed via any number of intermediate servers, or via a proxy server for example, before reaching the recipient trusted server, and any such intermediate data transfer step may use a unique encryption.

One consequence of the double trusted server solution of the present invention is that in such an arrangement, intuitive symmetrical keys may be used by both sender 12 and recipient 14, to communicate, with each sender/recipient being only required to trust the symmetrical key to a limited number of servers, typically one, whose security is trusted thereby.

When data communication such as e-mail occurs between users working for different corporations for example, the sender and intended recipient of the e-mail know with which corporation each other works, and the identity of the recipient trusted server is known to the sender. In practice many companies use a NAME@entity.com type e-mail address, and it is not known with which server the targeted e-mail account is served. With reference to FIG. 5, this issue may be dealt with by providing a hierarchical server arrangement wherein a plurality of servers are configured in a hierarchical arrangement, such that if a first server receiving data from a sender does not recognize the intended recipient thereof, said first server queries superior servers in said hierarchical arrangement in turn until an address of said recipient is found.

It will be appreciated that specific embodiments of the present invention may be configured in a number of ways. For example, a particular user might send all of his e-mails through the multiple encryption server structure of the present invention by configuring the terminal equipment of his client e-mail application to send all messages directly to the trusted encryption server. Alternatively, a client plug-in or application may forward all or some of the e-mail therefrom, through the trusted encryption server. Or in yet another alternative, the administrator of the user's organization might configure all outgoing mail of the organization through an encryption server.

Although because of its inherent advantages symmetrical encryption is generally preferred and is this encryption technique is facilitated for multiple users by preferred embodiments of the present invention, it will nevertheless be appreciated that the double encrypted server encryption techniques described hereinabove may use a wide range of encryption techniques for each of the encryption-decryption stages, including but not limited to hash functions, symmetrical and asymmetrical encryption techniques. Furthermore, the raw data transmitted may itself be encrypted; the secure socket layer (SSL) or indeed, any of the so-called OSI 7 layers may be encrypted.

Indeed, the first (sender trusted) and second (user trusted) encryption server may be a single server trusted by both, with the sender and recipient not even realizing that they are both subscribed to the same server.

Thus a new approach for data transmission is described, particularly for transmitting electronic mail between senders and recipients who do not trust the same server.

Persons skilled in the art will appreciate that the present invention is not limited to what has been particularly shown and described hereinabove. Rather the scope of the present invention is defined by the appended claims and includes combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A method of securely sending data from a sender to a recipient over a network, comprising the steps of:
(a) encrypting said data at terminal equipment of the sender via a first encryption key, thereby producing first encrypted data;
(b) transmitting said first encrypted data from said terminal equipment of said sender to a sender's encryption server;
(c) decrypting said first encrypted data at sender's encryption server using a first decryption key;
(d) identifying recipient's encryption server;
(e) establishing communication between sender's encryption server and recipient's encryption server;
(f) re-encrypting the data using a second encryption key, thereby producing second encrypted data;
(g) transmitting said second encrypted data from said sender's encryption server to said recipient's encryption server;
(h) decrypting said second encrypted data at said recipient's encryption server using a second decryption key;
(i) re-encrypting said data at the recipient's encryption server with a third encryption key thereby producing third encrypted data;
(j) transmitting said third encrypted data to said recipient;
(k) receiving said third encrypted data by said recipient, and
(l) decrypting the third encrypted data with a third decryption key.

2. The method of claim 1, wherein the first encryption key of step (a) and the first decryption key of step (c) are selected from the list of symmetrical key pairs and asymmetrical key pairs.

3. The method of claim 1, wherein the third encryption key of step (i) and the third decryption key of step (l) are selected from the list of symmetrical key pairs and asymmetrical key pairs.

4. The method of claim 1, wherein the second encryption key of step (f) and the second decryption key of step (h), are selected from the list of symmetrical key pairs and asymmetrical key pairs.

5. The method of claim 1, wherein the servers are networked in a peer-to-peer manner.

6. The method of claim 5, wherein the sender's encryption server and the recipient's encryption server are part of a hierarchical arrangement of servers, and step (e) of establishing communication between sender's encryption server and recipient's encryption server is achieved by each encryption server in said hierarchical arrangement of servers reporting back to servers thereabove regarding identity of accounts held therewith.

7. The method of claim 6, wherein if the sender's encryption server receiving data from the sender does not recognize intended recipient thereof, said sender's encryption server queries a master encryption server thereabove re address of said recipient's encryption server, and so on up hierarchical arrangement until an address of said recipient's encryption server is determined.

8. The method of claim 1, wherein the sender's encryption server comprises, either: a server on a node of the network, or a plurality of servers distributed over a plurality of nodes of the network.

9. The method of claim 1, wherein the recipient's encryption server comprises either: a serve on a node of the network, or a plurality of servers distributed over a plurality of nodes of the network.

10. The method of claim 1, wherein the network is selected from the list of LANS, WANS, intranets, and Internet.

11. An encryption server comprises a data receiver, a decryptor, an encryptor and a transmitter for facilitating secure data transmission by the method of claim 1.

12. A system for transmitting secure data between a sender's terminal equipment and a recipient's terminal equipment over a network, the system comprising:
a sender's encryption server and a recipient's encryption server;
each of said encryption servers comprising a data receiver, a decryptor, an encryptor and a transmitter;
the sender's encryption server being data connectable to the sender's terminal equipment over a first link of the network and to the recipient's encryption server over a second link of the network;
and the receiver's terminal equipment being data connectable to the recipient's terminal equipment over a third link of the network.
